(19) United States
(12) Patent Application Publication
(10) Pub. No.: US 2004/0140109 A1
(43) Pub. Date: Jul. 22, 2004

(54) Three-point hitch having flotation

(75) Inventors: Walter Mark Schlesser, Ottumwa, IA (US); Timothy J. Kraus, Hedrick, IA (US)

Correspondence Address: Jimmie R. Oaks, Patent Department, DEERE & COMPANY, One John Deere Place, Moline, IL, 61265-8098, US

(73) Assignee: Deere & Company, a Delaware corporation

(21) Appl. No.: 10/346,881

(22) Filed: Jan. 16, 2003

(51) Int. Cl. A01B 59/043; A01B 59/06; A01B 63/02; A01B 63/118

(52) U.S. Cl. 172/439

(57) ABSTRACT

A three-point hitch suitable for operation with wide implements is constructed by substituting a pair of flotation actuators for the usual drop links that are normally coupled between a pair of rocker arms and a pair of lower draft links. These drop links are coupled to a hydraulic circuit including, according to one embodiment, individual accumulators for each flotation actuator, and according to a second embodiment, both actuators are coupled to a single accumulator. The accumulator(s) act to cause a pre-selected lifting force to be exerted by the flotation actuators so that a predetermined amount of the weight of an implement mounted to the draft links is counterbalanced, leaving a desired ground pressure being exerted by the implement during operation. When using individual accumulators, a side-to-side weight balance can be achieved since different accumulator settings may be used.

### FIELD OF THE INVENTION

The present invention relates to a tractor three-point hitch.

### BACKGROUND OF THE INVENTION

A variety of different implements are compatible with common three-point hitching systems. Many implements, such as mower-conditioners, snow plows, etc need flotation in addition to height control to insure good performance and prevent damage. Presently, flotation is not available in common three-point hitching systems and must be designed into the implement.

### SUMMARY OF THE INVENTION

According to the present invention, there is provided an improved tractor three-point hitch.

An object of the invention is to provide a tractor three-point hitch arrangement which provides flotation.

A more specific object of the invention is to provide a three-point hitch arrangement which provides flotation and is achieved by making a relatively simple modification to a common three-point hitch arrangement.

Yet a more specific object of the invention is to provide a three-point hitch arrangement wherein drop links are formed of flotation cylinders which are either coupled to respective accumulators or are both coupled to the same accumulator.

These and other objects of the invention will become apparent from a reading of the ensuing description together with the appended drawings.

### BRIEF DESCRIPTION OF THE DRAWINGS

FIG. 1 is a perspective view of a tractor three-point hitch, which is representative of the prior art.

FIG. 2 is a perspective view of the tractor three-point hitch shown in FIG. 1, but modified for forming a three-point hitch constructed in accordance with the principles of the present invention.

FIG. 3 is a schematic view of a flotation control circuit constructed in accordance with a first embodiment.

FIG. 4 is a schematic view of a flotation control circuit constructed in accordance with a second embodiment.

### DESCRIPTION OF THE PREFERRED EMBODIMENT

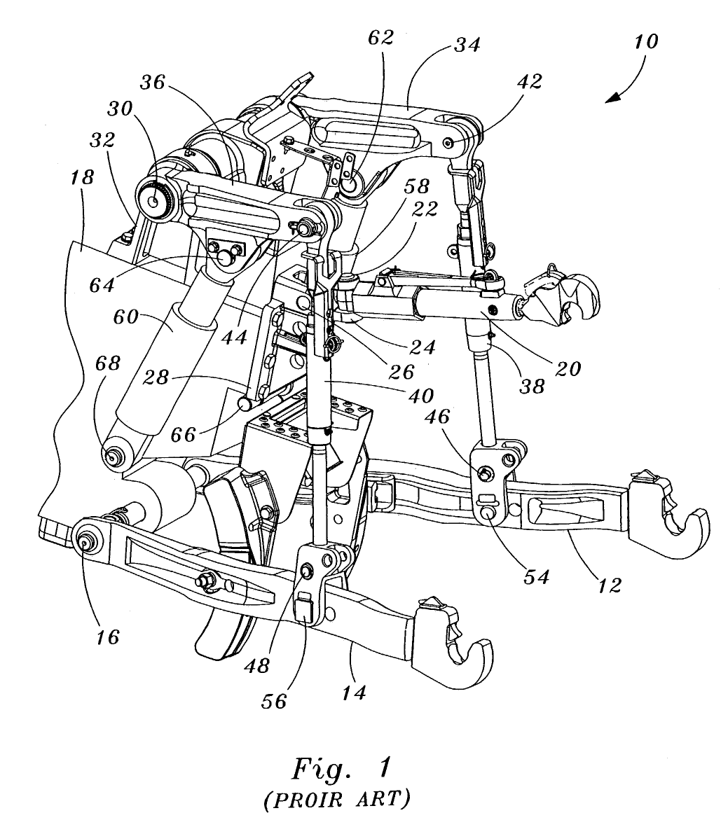

Referring now to FIG. 1, there is shown a tractor three-point hitch assembly 10 which is representative of the prior art. The three-point hitch assembly 10 may be mounted at either the front or the rear of a vehicle and includes, as viewed in the drawing, right- and left-hand lower draft links or arms 12 and 14 mounted for pivoting vertically about a horizontal transverse axis defined by a transverse shaft 16 fixed to a frame 18 of the carrying vehicle. An upper third draft link or arm 20, in the form of a length-adjustable turnbuckle has one end pivotally connected, as by a pin 22, to a bifurcated end of a yoke 24, and has its other end mounted for pivoting vertically about a horizontal transverse pin 26 coupled to a bracket 28 bolted to the vehicle frame 18 at a central location above and between the lower draft links 12 and 14. A horizontal, transverse rock shaft 30 is mounted for rotation within a support member 32 secured to the vehicle frame 18 at a location spaced substantially vertically above the support shaft 16 for the lower draft links. Mounted to the right- and left-hand ends of the rocker shaft 30 are rocker arms 34 and 46, respectively. A pair of lift links 38 and 40, respectively, have upper ends pivotally coupled to free ends of the rocker arms 34 and 36, as by horizontal transverse pins 42 and 44, and have bottom ends pivotally coupled, as by horizontal transverse pins 46 and 48, respectively, to yokes 50 and 52 having bifurcated lower ends coupled in straddling relationship to the draft links 12 and 14 by horizontal transverse pivot pins 54 and 56, respectively. Right- and left-hand lift cylinders 58 and 60, respectively, have upper ends pivotally coupled to the rocker arms 34 and 46, as at pins 62 and 64, and have lower ends pivotally coupled to the vehicle frame 18, as at pins 66 and 68.

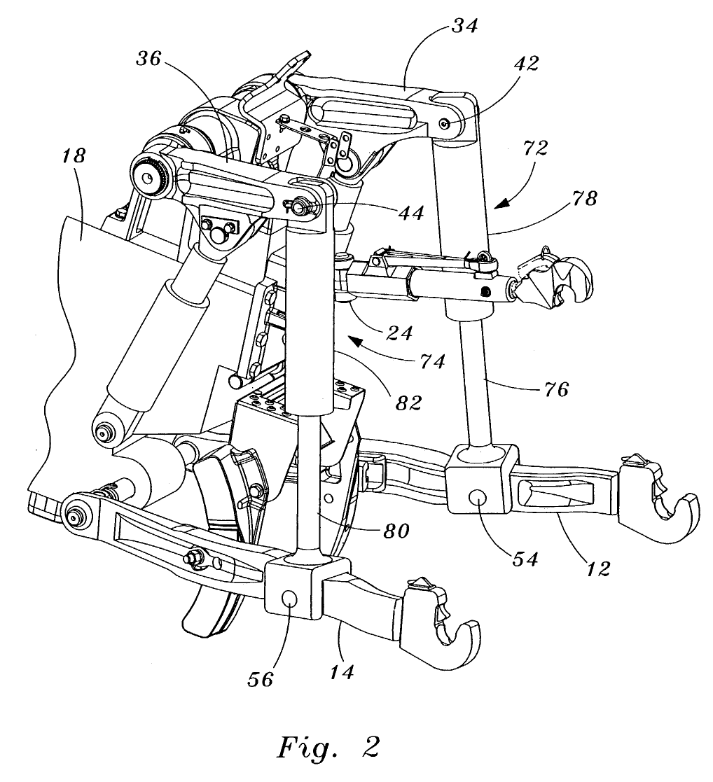

Referring now to FIG. 2, there is shown a three-point hitch assembly 70 incorporating the present invention, with components that are the same as those described above relative to FIG. 1, being given the same numeral call-outs. The only difference in the hitch assemblies 10 and 70 is that instead of the lift links 38 and 40 illustrated in FIG. 1, hydraulic float actuators 72 and 74 are provided. The hydraulic float actuator 72 includes a piston rod 76 having clevis at its lower end coupled to the lower draft link 12 by the pin 54 and a cylinder 78 having an upper end located between opposite lugs of a bifurcated free end of the right rocker arm 34 and coupled to the latter by the pin 42. Similarly, the float actuator 74 includes a piston rod 80 having a lower end defined by a clevis coupled to the draft link 14 by the pivot pin 56, and a cylinder 82 having an upper end located between lugs of a bifurcated free end of the rocker arm 36 and coupled thereto by the pin 44.

Referring now to FIG. 3, there is shown a flotation control circuit 84 constructed in accordance with a first embodiment and including right- and left-hand accumulators 86 and 88, respectively, coupled to the rod ends of the flotation cylinders 78 and 82 by respective branches 90 and 92 if a supply line 94 coupled to a supply pump 96 having an inlet coupled to a sump or reservoir 98. Right- and left-hand, three-way pressure-compensated make-up valves 100 and 102 are located in the branches 90 and 92 between the pump 96 and the respective accumulators 86 and 88.

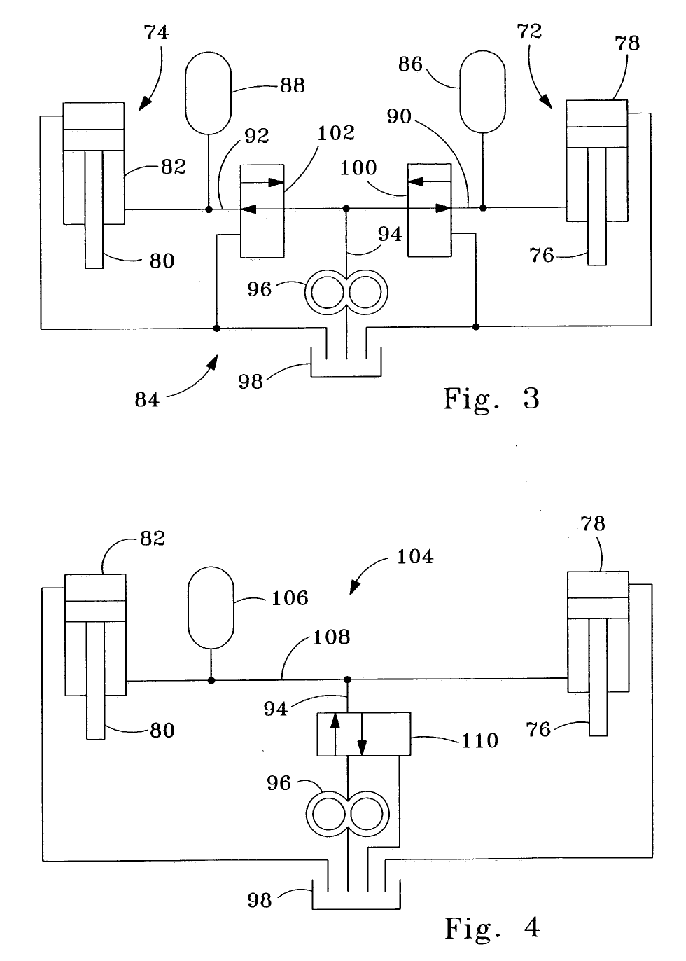

A control circuit 104, constructed in accordance with a second embodiment, is illustrated in FIG. 4. The control circuit 104 is a simplification of the circuit 84 in that it includes only one accumulator 106 and one branch conduit 108 coupled to the supply line 94 having it opposite ends coupled to the rod ends of the flotation actuators 72 and 74. Further, the control circuit 104 includes but one three-way, pressure-compensated valve 110 coupled in the supply line 94 between the pump 96 and the branch conduit 108.

In operation, assume the three-point hitch assembly 70 to be connected to an implement such as a wide area mower or the like, and for the flotation circuit 84 to be in use. When the work site is reached, the servo valve for controlling the lift actuators 58 and 60 is actuated to lower the implement and place the actuators in a float mode. The accumulators 86 and 88 will contain a pressure set to counterbalance the weight of the implement to the extent that only a small portion of the weight of the implement bears on the ground during operation. If the implement is not balanced in weight from side-to-side, then the accumulators 86 and 88 will be set at different pressures so that a balance in side-to-side ground pressure results for operation. Then, during operation, undulations in the work surface will result in the supports of the implement, usually skids or the like, to follow the ground contour, with fluid being automatically made up through operation of the pressure-compensated make-up valves 100 and 102. The operation is essentially the same if the control circuit 104 is used instead of the circuit 84, but here only one accumulator is used, so no side-to-side compensation is made for differences in weight at opposite sides of the longitudinal center line of the implement. In any event, when it is desired to once again raise the implement for transport, the cylinders of the actuators 58 and 60 are pressurized so as to effect a lifting action on the rocker arms 34 and 36, the latter acting through the float actuators 72 and 74 to lift the links 12 and 14.

Thus, it will be appreciated that by simply modifying a conventional three-point hitch assembly 10 by substituting hydraulic actuators for the lift links and providing a control circuit embodying accumulators for causing these actuators to have a desired float characteristic, a three-point hitch assembly having individually floating draft links suitable for operating with a wide implement is created.

Having described the preferred embodiment, it will become apparent that various modifications can be made without departing from the scope of the invention as defined in the accompanying claims.

1. In a hitch assembly including a support frame, a pair of draft links mounted to said frame for pivoting vertically about a first horizontal transverse axis, a rocker shaft mounted to said frame for rotating vertically about a second horizontal transverse axis spaced vertically from said first horizontal transverse axis, a pair of rocker arms respectively joined to transversely spaced locations of said rocker shaft, a pair of drop links respectively having upper ends pivotally coupled to said pair of rocker arms and having lower end respectively coupled to said pair of draft links, and a power lift actuator arrangement coupled between said frame and said rocker shaft for selectively raising and lowering said draft links through selected rotation of said rocker shaft, the improvement comprising: said pair of drop links being in the form of a pair of extensible and retractable hydraulic flotation actuators; and a control circuit coupled to said pair of hydraulic flotation actuators and including at least one accumulator coupled for resisting extension of said flotation actuators, and hence, downward movement of said pair of draft links.

2. The hitch assembly, as defined in claim 1, wherein said control circuit includes a second accumulator in addition to said at least one accumulator; said at least one accumulator being coupled only to a first one of said pair of flotation actuators; and said second accumulator being coupled only to a second one of said pair of flotation actuators.

3. The hitch assembly, as defined in claim 2, wherein said control circuit includes a source of fluid pressure; first and second pressure-compensated make-up valves coupled to said source of fluid pressure and respectively coupled to said first and second ones of said pair of flotation actuators.

4. The hitch assembly, as defined in claim 1, wherein a center link is pivotally mounted to said frame at a location centered above said pair of draft links.
